(19) United States
(12) Patent Application Publication
(10) Pub. No.: US 2009/0264581 A1
(43) Pub. Date: Oct. 22, 2009

(54) Polymeric Composite Material for Cold Molding and Process for Obtaining It

(75) Inventor: Filippo Randis, Como (IT)

Correspondence Address: SHOEMAKER AND MATTARE, LTD, 10 POST OFFICE ROAD - SUITE 100, SILVER SPRING, MD, 20910, US

(73) Assignee: Real Estate Service S.r.l., Saronno, Varese (IT)

(21) Appl. No.: 12/441,286

(22) PCT Filed: Oct. 12, 2006
(86) PCT No.: PCT/IT2006/000728

§ 371 Date: Apr. 2, 2009

(51) Int. Cl. C08L 63/10; B29C 45/00

(52) U.S. Cl. 524/508; 264/328.1; 525/132

(57) ABSTRACT

The present invention relates to a plastic composite material and a process for obtaining it. Particularly, the present invention relates to a polymeric composite material comprising an epoxy vinylester resin in which a filler is disupersed, said filler being polyethylene in particulate form, wherein said polyethylene is admixed in an amount less than 55% by weight relative to the epoxy vinylester resin, and a process for obtaining the same in which the resin/styrene mixture and the polyethylene is subjected to a treatment in vacuo and placed under stirring for more than 2 hours.

### FIELD OF THE INVENTION

The present invention relates to a plastic composite material for cold molding and a process for obtaining it.

### BACKGROUND ART

The use of plastic resins, such as polyester resins for obtaining high-performing materials is well known. A typical example is the so-called polymeric compounds, i.e. those materials deriving from the combination of two matrixes of different origins and with different characteristics, which when suitably combined with each other, form a material that maintains, at least partially, the characteristics of the matrixes of which it is composed. Most used materials include polyesters reinforced with glass fibers (Fiberglass™) or with polymeric materials or with a woven fabric, such as to give a multi-directional resistance thereto. Also known are vinyl ester resins, which due to their structure, have a good affinity with glass fibers. However, vinyl ester resins, despite their good resistance to chemical agents are not recommended for use in high-temperature applications.

The high performance of plastic materials such as polypropylene is also known. The drawback of these materials is, however, related to the molding process, which involves hot-molding operations being carried out in expensive steel molds, and with high tonnage presses.

### SUMMARY OF THE INVENTION

The object of the present invention is to provide a high-performing material, which is particularly provided with a considerable break resistance, asepticity, hydrophobicity, resistance to acids, high characteristics of acoustic and heat insulation, and the like, and which can be obtained by means of a simple and cost-effective process.

This object is achieved by a polymeric compound and a process for obtaining the same, such as defined in the annexed claims.

Further features and advantages of the composite material being the object of the present invention will be better understood from the description of some exemplary embodiments thereof, which is given herein below by way of non-limiting illustration.

### BRIEF DESCRIPTION OF THE DRAWINGS

FIG. 1 is a schematic perspective view of a plant for preparing the composite material of the invention.

### DETAILED DESCRIPTION OF THE INVENTION

The composite material according to the invention consists of a vinylester resin, in which a filler being a polyolefin, preferably selected from polypropylene and polyethylene, is admixed. More preferably, this polyolefin is polyethylene.

The vinylester resin is preferably an epoxy vinylester resin based on a bisphenol-A epoxy resin cross-linked with styrene in. a styrene percentage ranging between 30% and 50% by weight, preferably 35% to 45% by weight. This vinylester resin preferably has a density of more than 1 g/cc, more preferably ranging between 1.1 and 1.2 g/cc and a glass transition temperature ranging between 110° C. and 130° C.

In a preferred embodiment, the polyolefin is in a micronized form and has a grain size ranging between 20 μm and 50 μm, more preferably between 22 μm and 30 μm. Among the possible shapes of micronized particles, the spheroid shape is preferred.

In the composite material of the invention, the polyolefin is preferably admixed in an amount less than 55% by weight, more preferably between 35% and 50% by weight, most preferably about 40% by weight of the vinylester resin. It has been surprisingly observed that the polyolefin is capable of providing the polymeric compound with high characteristics of mechanical and acid resistance; with polyethylene, particularly, a higher performance is obtained than with polypropylene, which is more commonly used as a filler in similar prior art applications.

The composite material of the invention will further contain a cross-linking catalyst and a primer, as will be better discussed herein below.

The polymeric compound of the invention may further contain a suitable pigment or colouring agent, such as to provide the same with the desired aesthetic appearance.

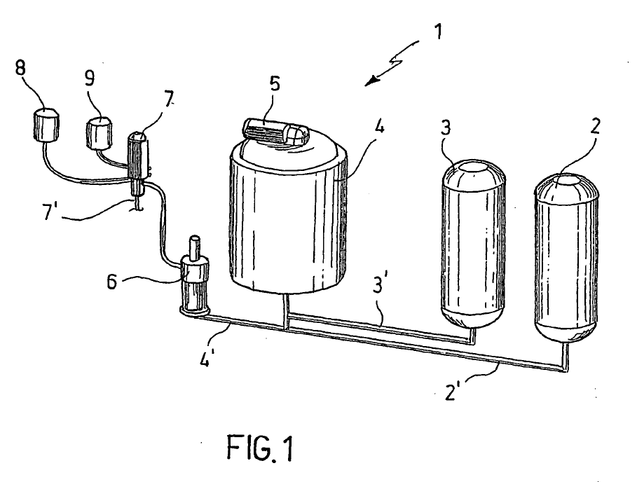

The process for preparing the polymeric composite material in accordance with the invention will be now described with the aid of FIG. 1, which schematically shows a system 1 to be used for this process.

The system 1 consists of a first reservoir 2 for the vinylester resin (resin +styrenic crosslinker) and a second reservoir 3 for the polyolefin. These reservoirs 2, 3 are communicated, through respective tubes 2′, 3′, with the bottom of a chamber 4 provided with a stirrer, in which vacuum is created by means of suitable air-exhausting means 5. The bottom of the chamber 4 is also in fluid communication, through a tube 4′, with pump means 6 that provide to feed the material mixture to mixing means 7, typically a dynamic mixer. The catalyst and the pigment or colouring agent, which are contained in respective reservoirs 8, 9, are also fed to the mixing means 7. By means of a tube 7′, the mixing means 7 feed the reactant mixture directly to a mold (not shown), where the composite material is formed. Suitable valves and a command and control unit provide to control the material flows in accordance with the modalities of the process which will be described herein below.

Practically, the vinylester resin and the polyolefin are loaded, in the ratios indicated above, to the chamber 4 and are subjected to vacuum treatment (5 bar depression) under stirring for more than 2 hours, preferably more than 3 hours, most preferably about 4 hours. The vacuum treatment is very important for preventing the generation of bubbles during the crosslinking reaction. Thereby, the final characteristics of the composite are improved.

When this treatment has been completed, the mixture is transferred, by means of the pump means 6, to the mixing means 7, where it is added with the suitable amount of catalyst/primer and colouring agent or pigment. At the end of the addition, the reactant mixture is poured in the mold, where the crosslinking reaction and the consequent formation of the polymeric composite material will be completed. The reaction is exothermic, such that temperatures of 70-80° C. can be reached, and is normally completed in a rather short time (a few minutes). It is important to obtain a proper mixing of all the components provided in the mixing means 7, particularly the resin and polyethylene in order to obtain an homogeneous composite material.

The colouring agent or pigment is mixed with the other components in a weight ratio ranging between 1% and 3%, preferably about 2% by weight.

The catalyst is admixed with the other components in a weight ratio ranging between 1% and 3%, preferably between 1.5% and 2% by weight. As the catalyst, a peroxide such as acetyl acetone peroxide or methyl ethyl ketone peroxide is normally used. Preferably, a suitable primer/accelerator will be also used, particularly a cobalt salt, preferably Co octanoate, in a ratio ranging between 6% and 12% by weight. The accelerator ratio can be changed according to the type of product desired to be produced, and the concentration thereof depends on the thickness of the product and time required for curing. When the thickness values are relatively thin, it has been found advantageous to use a concentration ranging between 2% and 3%, and preferably about 2.5% relative to the resin weight. In the case of very thick products, in which releasing the heat generated by the hardening reaction may result to be difficult, the use has been found advantageous of a catalyst formed by methyl ethyl ketone peroxide with weight ratios ranging between 0.5% and 5%, and particularly between 1% and 4% of the resin, with the aid of an accelerator formed by Co salts in a ratio ranging between 2% and 3%, and preferably about 2.5% by weight of the resin.

When desiring to manufacture light-coloured or transparent products, instead of Co salts as the accelerators, the use of N,N-diethylacetoacetamide is preferred in a concentration ranging between 0.05% and 0.4%, and preferably between 0.1% and 0.4% by weigh of the resin.

The polymeric composite material according to the invention is provided with such characteristics as to be used for high-performing applications. It is characterized, in fact, by high mechanical resistance and resistance to corrosive elements, it is aseptic, water-repellent, unscratchable and can be easily molded, milled, threaded or tapped. Accordingly, a typical application field for this material is furniture elements, and particularly kitchen worktops, and most particularly, counters in technical laboratories. For example, a surface can be molded with a sink being integrally modelled therein.

It has been surprisingly observed that the polymeric compound of the invention has considerable heat insulation characteristics. This characteristic is surprising, in that the vinylester resin is normally not recommended for high temperature applications. Due to this characteristic, the inventive material may be effectively used for manufacturing heat-insulating panels.

The inventive material also has considerable sound insulating characteristics and can be thus advantageously employed for manufacturing hi-fi speakers.

Due to the hydrophobicity and mechanical-chemical resistance, the inventive material can be efficiently used for manufacturing pots for flowers and plants.

A last, non-negligible advantage of the inventive material is its low cost, which is also a result of the simple manufacturing process thereof, which does not require using steel molds for high-temperature injection and high tonnage presses.

It will be appreciated that only some particular embodiments of the polymeric composite material being the object of the present invention and of the process for obtaining it have been described herein, to which those skilled in the art will be able to make any and all modifications required for adapting the same to specific applications, without however departing from the scope of protection of the present invention.

For example, it may be possible to further improve the performance of the composite material of the invention, by including therein, for example during the step of molding, fibers or woven fibers of different materials, such as glass fibers, within the molds.

1-21. (canceled)

22. A polymeric composite material comprising an epoxy vinylester resin in which a filler is dispersed, said filler being a polyolefin in particulate form, wherein said polyolefin is mixed in an amount less than 55% by weight relative to the epoxy vinylester resin.

23. The polymeric composite material according to claim 22, wherein said polyolefin is mixed in an amount ranging between 35% and 50% by weight, preferably about 40% by weight, relative to the epoxy vinylester resin.

24. The polymeric composite material according to claim 22, wherein said polyolefin is used in a spheroid particulate form.

25. The polymeric composite material according to claim 24, wherein said polyolefin is micronized and has a grain size ranging between 20 μm and 50 μm.

26. The polymeric composite material according to claim 25, wherein said polyolefin has a grain size ranging between 22 μm and 30 μm.

27. The polymeric composite material according to claim 22, wherein said polyolefin is selected from polypropylene and polyethylene, preferably polyethylene.

28. The polymeric composite material according to claim 22, wherein said epoxy vinylester resin is based on an epoxy resin of bisphenol-A crosslinked with styrene in a styrene percentage between 30% and 50% by weight, preferably between 35% and 45% by weight.

29. The polymeric composite material according to claim 28, wherein said epoxy vinylester resin has a density higher than 1 g/cc, preferably ranging between 1.1 and 1.2 g/cc and a glass transition temperature ranging between 110° C. and 130° C.

30. The polymeric composite material according to claim 22, wherein said material comprises a coloring agent or pigment.

31. The polymeric composite material according to claim 30, wherein said coloring agent or pigment is contained in a ratio between 1% and 3% by weight, preferably about 2% by weight.

32. The process for obtaining the polymeric composite material according to claim 22, comprising the steps of:
subjecting a mixture of epoxy vinylester resin/styrene and polyolefin in particulate form, in which said polyolefin is admixed in an amount less than 55% by weight relative to the epoxy vinylester resin, to a vacuum treatment and under stirring for more than 2 hours;
adding, by means of mixing means, a coloring agent or pigment and a catalyst/primer to said mixture treated under vacuum;
injecting the thus-obtained mixture in a mold until solidification.

33. The process according to claim 32, wherein said catalyst is a peroxide and said primer is a cobalt salt, or N,N-diethylacetoacetamide.

34. The process according to claim 33, wherein said peroxide is acetyl acetone peroxide or methyl ethyl ketone peroxide.

35. The process according to claim 33, wherein said cobalt salt is Co octanoate.

36. The process according to claim 33, wherein, when said catalyst is acetyl acetone peroxide, this is used in amounts ranging between 1% and 3%, preferably between 1.5% and 2% by weight of the resin.

37. The process according to claim 33, wherein, when said catalyst is methyl ethyl ketone peroxide, this is used in amounts ranging between 0.5% and 5%, preferably between 1% and 4% by weight of the resin.

38. The process according to claim 33, wherein, when said primer is a Cobalt salt, this is used in amounts ranging between 2% and 3%, for thin thickness values of the product, or between 6% and 12% by weight of the resin.

39. The process according to claim 33, wherein, when said primer is N,N-diethylacetoacetamide, this is used in amounts ranging between 0.05% and 0.4%, preferably between 0.1% and 0.4% by weight of the resin.

40. The process according to claim 32, wherein said coloring agent or pigment is used in amounts ranging between 1% and 3% by weight, preferably about 2% by weight.

41. The polymeric composite material comprising an epoxy vinylester resin in which a filler is dispersed, said filler being a polyolefin in particulate form, wherein said polyolefin is mixed in an amount less than 55% by weight relative to the epoxy vinylester resin, which can be obtained with the process according to claim 32.

42. A product made with a polymeric composite material according to claim 41, said product being preferably a kitchen or laboratory worktop, a speaker, a heat-insulating panel or furniture element, or parts thereof.
